(19) United States
(12) Patent Application Publication
(10) Pub. No.: US 2010/0176229 A1
(43) Pub. Date: Jul. 15, 2010

(54) Bin full detector for shreder

(75) Inventors: Yung-Hao Huang, SanChung City (TW); Tsung-Pin Ting, ChangAn (CN); Shao-Ji Huang, ChangAn (CN); Jian-Xiong Li, ChangAn (CN); Zhi-Neng Chen, ChangAn (CN)

Correspondence Address: BACON & THOMAS, PLLC, 625 SLATERS LANE, FOURTH FLOOR, ALEXANDRIA, VA, 22314-1176, US

(73) Assignee: Michilin Prosperity Co., Ltd., SanChung City (TW)

(21) Appl. No.: 12/318,982

(22) Filed: Jan. 14, 2009

(51) Int. Cl. B02C 23/00

(52) U.S. Cl. 241/100

(57) ABSTRACT

This specification discloses a bin full detector for shredder. A bin full detector is disposed in the bottom of the shredder housing at a position not lower than the blade set of the shredder. The bin full detector includes at least one emitted for emitting an infrared beam downward to the paper chips and at least one receiver for receiving the reflected signal. The feedback signals from chips of different distances or heights are converted into different voltages and sent to a signal processing circuit. A microcontroller analyzes, computes, and compares the signals. Finally, a displaying unit shows to the user whether the paper chips in the bin need to be emptied.

### BACKGROUND OF THE INVENTION

1. Field of Invention

The invention relates to a shredder. In particular, the invention relates to a bin full detector for shredder that enables a user to know whether the height of paper chips inside the bin has reached the level for cleaning.

2. Related Art

To prevent such documents as legal files, receipts, invoices, credit card numbers, research reports, or personal financial information (e.g., credit card and phone bills) from being released, it is common to destroy them using a shredder. Therefore, the shredder has become an indispensable device for both business and home applications.

A usual shredder includes a housing, a paper inlet for the insertion of paper, and a shredder mechanism disposed inside the housing for shredding paper. The shredder mechanism includes cutting blades mounted on rotary shafts. A motor and a gearbox drive the two parallel rotary shafts rotating in opposite directions to cut passing paper sheets into chips. Normally, the shredder is provided with a basket or bin for holding paper chips. The shredded chips accumulate in an irregular way in the bin. However, they often accumulate underneath the paper outlet and form a chip mountain. When the chip mountain is high enough to reach the bottom of the shredder mechanism, it hinders subsequent chips from falling conveniently and may even cause jams when they are shoveled into the gaps between cutting blades. This affects the normal functions of the shredder. Therefore, when the chips inside the bin accumulate to a certain extent, the bin should be emptied immediately in order to avoid paper jams.

Hence, the full bin indicator of the bin has been introduced to the field. U.S. Pat. No. 7,204,441 discloses a mechanical full bin indictor. During the accumulating process of the paper chips, they touch an indicator board and push it to flip outward. The BIN FULL sign thereon can be read by the user to know that the bin is full. On the other hand, U.S. Pat. No. 6,978,954 discloses an electrical detecting device. Under the cutting blades or the upper opening of the bin, the emit end and receive end of infrared (IR) beams are disposed horizontally and opposite to each other. When the horizontally opposite IR beams are continuously blocked by paper chips over a preset period of time, the shredder stops its operation. A bin full light or buzzer is used to notify the user about the bin full state of the bin. On the other hand, if the time of the IR beam being blocked by the chips is not over the preset period of time, the shredder continues its operation.

Since the above-mentioned detecting device has oppositely shooting IR beams under the cutting blades of the shredder, the shredded chips certainly block the beams intermittently. Therefore, the detecting device has to be provided with a timer set to make sure that the blocked IR beams are caused by highly accumulated chips, instead of falling chips. Therefore, the required precision and cost of the detecting device are high, rendering the products less competitive.

### SUMMARY OF THE INVENTION

In view of the foregoing, an objective of the invention is to provide a bin full detector for shredder. A bin full detector is disposed in the bottom portion of a shredder housing at a position not lower than its blade set. The bin full detector includes at least one emitted for emitting an infrared beam downward to the paper chips and at least one receiver for receiving the reflected signal. The feedback signals from chips of different distances or heights are converted into different voltages and sent to a signal processing circuit. A microcontroller (MCU) analyzes, computes, and compares the signals. Finally, a displaying unit such as a light-emitting diode (LED), liquid crystal display (LCD), or buzzer shows to the user whether the paper chips in the bin need to be emptied.

### BRIEF DESCRIPTION OF THE DRAWINGS

The invention will become more fully understood from the detailed description given herein below illustration only, and thus is not limitative of the present invention, and wherein:

FIG. 1 shows the configuration of the disclosed bin full detector for shredder.

### DETAILED DESCRIPTION OF THE INVENTION

The present invention will be apparent from the following detailed description, which proceeds with reference to the accompanying drawings, wherein the same references relate to the same elements.

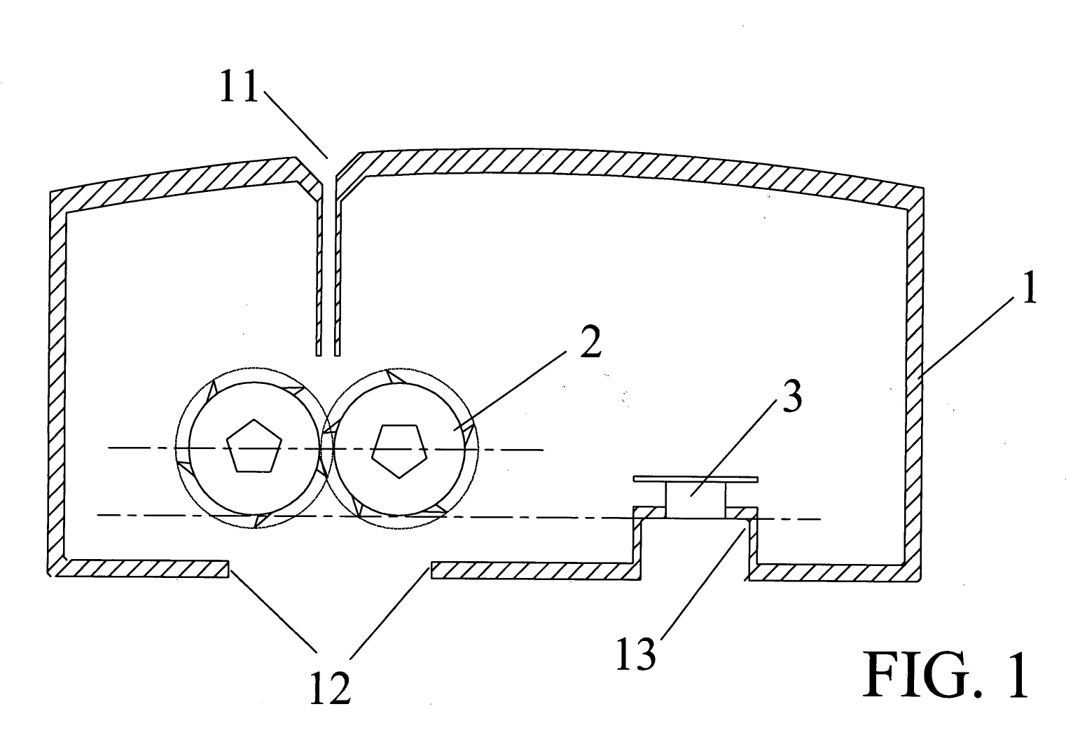

Please refer to FIG. 1 for the configuration of the disclosed bin full detector for shredder. As shown in the drawing, the top surface of a shredder housing 1 has a paper inlet 11 for the insertion of paper sheets. A blade set 2 for shredding paper is disposed inside the housing. The bottom surface of the housing 1 opposite to the blade set 2 is an open paper outlet 12. A concave portion 13 is formed at the back of the paper outlet 12 on the housing 1. The depth of the concave portion 13 is slightly larger than the blade set 2. A bin full detector 3 is disposed in the concave portion 13.

The action principle of the bin full detector 3 is as follows. An emitter (not shown) emits an infrared (IR) beam downward to the chips. A receiver (not shown) receives reflected signals. The feedback signals from chips of different distances or heights are converted into different voltages and sent to a signal processing circuit (not shown). The microcontroller (not shown) analyzes, computes, and compares the signals. A displaying unit such as LED, LCD, or buzzer (not shown) shows to the user whether the paper chips in the bin need to be emptied.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A bin full detector for shredder, wherein a top surface of the housing of the shredder has a paper inlet for the insertion of paper sheets, a blade set for shredding paper is disposed in the housing, the bottom surface of the housing underneath the blade set has an open paper outlet, and a concave portion is formed at an appropriate position in the bottom surface of the housing to accommodate a bin full detector.

2. The bin full detector for shredder of claim 1, wherein the concave portion is formed at the back of the paper outlet of the housing.

3. The bin full detector for shredder of claim 1, wherein the horizontal position of the bin full detector is slightly higher than the blade set.

4. The bin full detector for shredder of claim 1, wherein the bin full detector emits a beam using at least one emitter, receives reflected signals using at least one receiver, converts feedback signals from reflecting objects of different distances or heights into different voltages and sends them to a signal processing circuit, uses a microcontroller to analyze, compute, and compare the signals, and shows the detected result using a displaying unit.

5. The bin full detector for shredder of claim 4, wherein the beam is infrared light.

6. The bin full detector for shredder of claim 4, wherein the displaying unit is a light-emitting diode (LED).

7. The bin full detector for shredder of claim 4, wherein the displaying unit is a liquid crystal display (LCD).

8. The bin full detector for shredder of claim 4, wherein the displaying unit is a buzzer.
